(19) United States
(12) Patent Application Publication
(10) Pub. No.: US 2015/0124442 A1
(43) Pub. Date: May 7, 2015

(54) SEVEN-COLORED SWINGING ELECTRONIC CANDLE

(71) Applicant: Nantong Ya Tai Candle Arts & Crafts Co., Ltd., Nantong City (CN)

(72) Inventor: Yingqi Ding, Nantong City (CN)

(73) Assignee: Nantong Ya Tai Candle Arts & Crafts Co., Ltd., Nantong City (CN)

(21) Appl. No.: 14/165,797

(22) Filed: Jan. 28, 2014

(30) Foreign Application Priority Data
Nov. 6, 2013 (CN) 2013105432929

(51) Int. Cl. F21S 10/04; F21V 23/00

(52) U.S. Cl. CPC F21S 10/046; F21V 23/005; F21Y 2101/02
USPC 362/231

(57) ABSTRACT

The present invention discloses a seven-colored swinging electronic candle, which comprises a candle body, a cavity is arranged in said candle body, a support is arranged in said cavity, a support frame which can swing around, is installed on said support, a candle wick is fixed in said support frame, wherein said candle wick comprises a flame front and a candle end which is connected to said flame front, a light-resisting body is arranged on the surface of said flame front, a permanent magnet is arranged below said candle end, an electromagnetic coil is arranged just under said permanent magnet; outside said support, the support bases are arranged above said candle body; a colorful light-emitting body and a white light-emitting body are respectively arranged on said support bases, the light from said white light-emitting body illuminates on said light-resisting body. The electronic candle described in the present invention has a dynamic effect, rich light colors, a strong aesthetic feeling, and a high simulation degree.

### TECHNICAL FIELD

The present invention relates to an electronic candle, and in particular, an electronic candle integrating seven-colored light emitting and swinging functions.

### BACKGROUND ART

Since its introduction, the electronic candle becomes more and more popular among people for its safety and convenience, saving energy and environmental protection. Especially in Europe and America, it has a trend of replacing traditional candles gradually.

However, most of existing electronic candles have only a single-colored light-emitting body without dynamic effect and feeling of flickering lights, for lack of reality and a high degree of simulation. The other existing electronic candles carry out colorful light guiding by adopting optical fiber cores, which causes higher production cost.

### SUMMARY OF THE INVENTION

Invention object: the object of the present invention is to provide an electronic candle integrating seven-colored light emitting and swinging functions for solving the defect of the prior art. The electronic candle is capable of simulating the dynamic effect of the flame front of a candle.

Technical solution: the seven-colored swinging electronic candle described in the present invention comprises a candle body, a cavity is arranged in said candle body, a support is arranged in said cavity, a support frame which can swing around, is installed on said support, a candle wick is fixed in said support frame, wherein said candle wick comprises a flame front and a candle end which is connected to said flame front, a light-resisting body is arranged on the surface of said flame front, a permanent magnet is arranged below said candle end, an electromagnetic coil is arranged just under said permanent magnet; outside said support, the support bases are arranged above said candle body; a colorful light-emitting body and a white light-emitting body are respectively arranged on said support bases, the light from said white light-emitting body illuminates on said light-resisting body.

It is preferred that the light-resisting body is located on one side or both sides of the flame front.

It is preferred that the light-resisting body is located at the lower part of the flame front.

It is preferred that the light-resisting body is one of white paper, a white plastic skin, a white plastic sheet and white coating.

It is preferred that the light-resisting body is pasted or embedded on the flame front.

It is preferred that, there are two support bases which are respectively symmetrically located on the front surface and the back surface of the flame front.

It is preferred that the colorful light-emitting body is a seven-colored LED lamp. It is preferred that the white light-emitting body is a white-light LED lamp or yellow-light LED lamp.

It is preferred that the colorful light-emitting body, the white light-emitting body and said electromagnetic coil are electrically connected with a circuit board respectively, and the circuit board is electrically connected with a battery.

It is preferred that a drive device which is arranged on the circuit board, is used for driving the colorful light-emitting body and the white light-emitting body

The candle body of the swinging electronic candle described in the present invention may be a wax candle body, a plastic candle body, or wax liquid or a waxy candle body filled in a glass container or transparent container or a light-emitting body like the candle in shape, and the light-emitting body adopts a swinging candle wick of the swinging electronic candle provided by the present invention.

Beneficial effects: In present invention, the light from two light-emitting bodies illuminate the flame front. With the swinging of the candle wick, the electronic candle described in the present invention is capable of completely simulating the dynamic effect of the flame front completely. And this effect of simulation is very high in simulation degree, and is colorful, flickering and attractive.

### DESCRIPTION OF THE DRAWINGS

FIG. 1 is a schematic structural diagram of the present invention. FIG. 2 is a schematic structural diagram of a candle wick of the present invention.

### SPECIFIC EMBODIMENTS

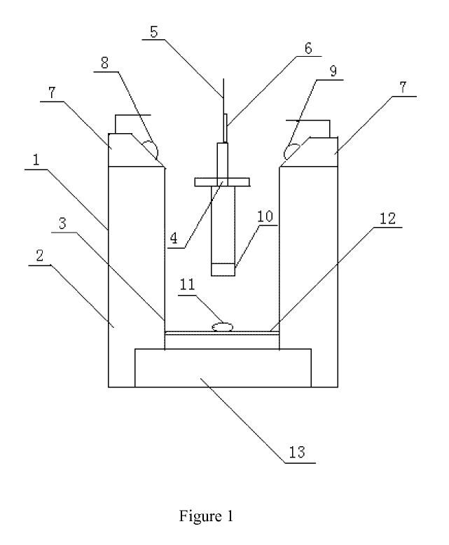

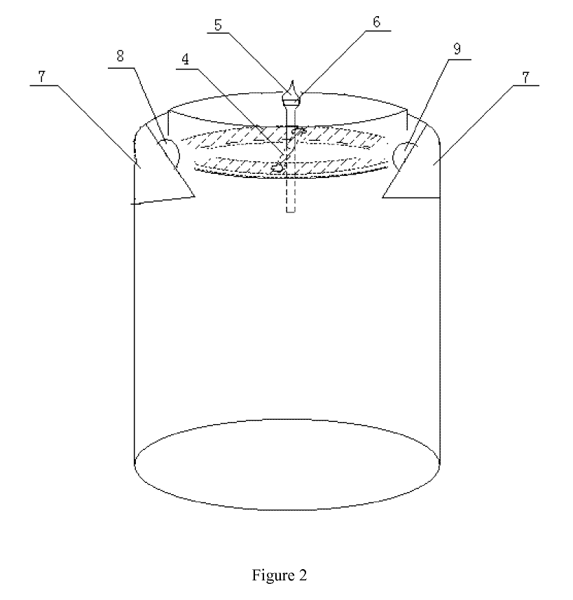

As shown in FIG. 1 and FIG. 2, the seven-colored swinging electronic candle comprises a candle body 1, wherein a cavity 2 is arranged in the candle body 1. A support 3 is arranged in the cavity 2. A support frame 4 which can swing around, is installed on the support 3. A candle wick is fixed to the support frame 4. The candle wick includes a flame front 5 and a candle end connected with the flame front 5. A light-resisting body 6 is arranged on the surface of the flame front 5. An permanent magnet 10 is arranged below the candle end. An electromagnetic coil 11 is arranged just below the permanent magnet 10. Outside the support 3, the support bases 7 are arranged above the candle body 1. A colorful light-emitting body 8 and a white light-emitting body 9 are respectively located on the support bases 7, light from the white light-emitting body 9 illuminates on the light-resisting body 6, and light from the colorful light-emitting body illuminates on the surface of the flame front 5 with the exception of the light-resisting body 6. The light-resisting body 6 located at the lower part of the flame front 5, is arranged on one side or both two sides of the flame front 5. The light-resisting body 6 which is pasted or embedded on the flame front 5, could be one of white paper, a white plastic skin, a white plastic sheet and white coating. There are two support bases 7 which are respectively symmetrically arranged at the front surface and the back surface of the flame front 5. The color light-emitting body 8 is a colorful LED lamp. The white light-emitting body 9 is a white-light LED lamp or yellow-light LED lamp. The colorful light-emitting body 8, the white light-emitting body 9 and the electromagnetic coil 11 are all electrically connected with a circuit board 12. This circuit board 12 is electrically connected with a battery 13. A drive device for the colorful light-emitting body 8 and the white light-emitting body 9 is arranged on the circuit board 12. The drive device randomly generates a current pulse to stimulate the electromagnetic coil 11. The electromagnetic coil 11 generates a magnetic field to make the candle end and flame front 5 swing. Therefore the users will see the flicker.

The principle of present invention is that with light from the white light-emitting body 9 illuminates on the light-resisting body 6 of the flame front 5, whereas light from the colorful light-emitting body 8 illuminates on the surface of flame front 5, with the exception of the light-resisting body 6. A kind of flame with a white or yellow flame core in the middle and colorful outer part is formed. In combination with the swinging dynamic effect of the flame front 5, a simulation effect like a real flame of a candle is formed. The electronic candle is very high in simulation degree, and is colorful, flickering and attractive.

1. A seven-colored swinging electronic candle, comprising:
a candle body;
a cavity arranged in said candle body;
a support arranged in said cavity;
a support frame which can swing around, is installed on said support;
a candle wick fixed in said support frame;
wherein said candle wick comprises a flame front and a candle end which is connected to said flame front;
a light-resisting body arranged on a surface of said flame front;
a permanent magnet arranged below said candle end;
an electromagnetic coil arranged just under said permanent magnet; outside said support, support bases are arranged above said candle body;
a colorful light-emitting body and a white light-emitting body are respectively arranged on said support bases light from said white light-emitting body illuminates on said light-resisting body.

2. The seven-colored swinging electronic candle according to claim 1,
wherein said light-resisting body is located on one side or both sides of said flame front.

3. The seven-colored swinging electronic candle according to claim 1,
wherein said light-resisting body is located at a lower part of said flame front.

4. The seven-colored swinging electronic candle according to claim 1,
wherein said light-resisting body is one of white paper, a white plastic skin, a white plastic sheet and white coating.

5. The seven-colored swinging electronic candle according to claim 1,
wherein said light-resisting body is pasted or embedded on said flame front.

6. The seven-colored swinging electronic candle according to claim 1,
wherein there are two support bases which are respectively symmetrically located on the front surface and the back surface of said flame front.

7. The seven-colored swinging electronic candle according to claim 1,
wherein said colorful light-emitting body is a seven-colored LED lamp.

8. The seven-colored swinging electronic candle according to claim 1,
wherein said white light-emitting body is a white-light LED lamp or a yellow-light LED lamp.

9. The seven-colored swinging electronic candle according to claim 1,
wherein said colorful light-emitting body, said white light-emitting body and said electromagnetic coil are electrically connected with a circuit board respectively, and said circuit board is electrically connected with a battery.

10. The seven-colored swinging electronic candle according to claim 8,
wherein a drive device which is arranged on the circuit board, is used for driving said colorful light-emitting body and said white light-emitting body.
